(19) United States
(12) Patent Application Publication
(10) Pub. No.: US 2020/0010732 A1
(43) Pub. Date: Jan. 9, 2020

(54) REMOVABLE PRESSURE-SENSITIVE ADHESIVE STRIP

(71) Applicant: TESA SE, Norderstedt (DE)

(72) Inventors: Beatrice SALERT, Hamburg (DE); Michael EGGER, Hamburg (DE); CaiRong LIM, Hamburg (DE)

(73) Assignee: TESA SE, Norderstedt (DE)

(21) Appl. No.: 16/488,472

(22) PCT Filed: Jan. 29, 2018
(86) PCT No.: PCT/EP2018/052137

§ 371 Date: Aug. 23, 2019

(30) Foreign Application Priority Data
Feb. 24, 2017 (DE) 10 2017 203 092.5

(51) Int. Cl. C09J 7/38; C09J 109/02

(52) U.S. Cl. CPC C09J 7/383; C09J 109/02; C09J 7/385; C09J 2475/006; C09J 2203/30; C09J 2409/00; C09J 2201/618

(57) ABSTRACT

Disclosed is a pressure-sensitive adhesive strip comprising a carrier and a pressure-sensitive adhesive compound layer HS1 on one of the surfaces of said carrier, wherein (i) the carrier has a breaking elongation of at least 250% in the longitudinal direction and/or transverse direction, and (ii) the pressure-sensitive adhesive compound layer HS1 consists of a pressure-sensitive adhesive compound which contains, as the base polymer, at least one solid acrylonitrile-butadiene rubber as well as at least one adhesive resin, wherein the proportion of adhesive resin is in total 30 to 130 phr.

This application is a § 371 national stage of PCT International Application No. PCT/EP2018/052137, filed Jan. 29, 2018, which claims foreign priority benefit under 35 U.S.C. § 119 of German Patent Application No. 10 2017 203 092.5, filed Feb. 24, 2017, the disclosures of each of which are incorporated herein by reference.

The invention relates to a pressure-sensitive adhesive strip based on acrylonitrile-butadiene rubber, which can be used to produce a bond which can be parted again by extensive stretching.

Pressure-sensitive adhesive tapes which have high elastic or plastic extensibility and which can be redetached without residue or destruction by extensive stretching within the bond plane, i.e., at a removal angle of 0°, are known from, for example, U.S. Pat. No. 4,024,312 A, DE 33 31 016 C2, WO 92/11332 A1, WO 92/11333 A1, DE 42 22 849 01, WO 95/06691 A1, DE 195 31 696 A1, DE 196 26 870 A1, DE 196 49 727 A1, DE 196 49 728 A1, DE 196 49 729 A1, DE 197 08 364 A1, DE 197 20 145 A1, DE 198 20 858 A1, WO 99/37729 A1and DE 100 03 318 A1 and are also referred to below as strippable pressure-sensitive adhesive tapes.

These kinds of strippable pressure-sensitive adhesive tapes are oftentimes used in the form of adhesive film strips which are pressure-sensitive on one or both sides, preferably having a non-pressure-sensitive adhesive grip region from which the detachment operation is initiated. Particular applications of such pressure-sensitive adhesive tapes are found in publications including DE 42 33 872 01, DE 195 11 288 01, U.S. Pat. 5,507,464 B1, U.S. Pat. No. 5,672,402 B1 and WO 94/21157 A1. Specific embodiments are also described in DE 44 28 587 01, DE 44 31 914 01, WO 97/07172 A1, DE 196 27 400 A1, WO 98/03601 A1 and DE 196 49 636 A1, DE 197 20 526 A1, DE 197 23 177 A1, DE 197 23 198 A1, DE 197 26 375 A1, DE 197 56 084 01, DE 197 56 816 A1, DE 198 42 864 A1, DE 198 42 865 A1, WO 99/31193 A1, WO 99/37729 A1, WO 99/63018 A1, WO 00/12644 A1 and DE 199 38 693 A1.

Preferred fields of use of aforementioned strippable adhesive film strips include in particular the residuelessly and nondestructively redetachable fixing of light-weight to medium-weight articles in the residential, work, and office segments. For use in the work and office segments, the products used are generally of considerable thickness, of more than 400 μm. In the consumer electronics industry—such as, for example, in the production of mobile telephones, digital cameras or laptops—there is an ever-growing desire for a possibility of separating the individual components on disposal after they have been used. Some components can then be reused or recycled—or at least separate disposal is made possible. There is therefore great interest within this industry in releasable adhesive bonds. In particular, adhesive tapes which can be easily removed as and when desired, while possessing a high holding power, constitute a reasonable alternative here to adhesive strips which must first be pretreated, by heating, for example, in order to be detached. Within the consumer electronics segment, the preference is for adhesive strips which are extremely thin, since the end devices are to be extremely thin and hence all of the individual components are to take up little space as well.

When very thin strippable adhesive strips are used which operate without carriers, there is increased incidence of tears (see DE 33 31 016 C2). If the adhesive strips tear, then detachment is generally no longer possible, however, since the remnant of the adhesive strip springs back into the joint and there is therefore no grip tab available.

WO 92/11333 A1 describes a strippable adhesive tape which uses as its carrier a highly stretchable film with a resilience after stretching of <50%.

WO 92/11332 A1 describes an adhesive film strip which is redetachable by pulling in the bond plane and for which the carrier utilized may be a highly stretchable, substantially nonresilient film. Adhesives employed are exclusively UV-crosslinked acrylate copolymers, with which it is not possible to achieve the high bond strengths, and which undergo a smaller loss of peel adhesion during stretching than is the case, for example, for adhesives based on vinylaromatic block copolymer.

Further publications such as WO 2010/141248 A1 describe systems comprising pressure-sensitive polyisobutylene adhesives, which likewise exhibit a low peel adhesion.

A strippable adhesive film strip having a foamed, non-pressure-sensitive adhesive film carrier is described in WO 95/06691 A1, DE 196 49 727 A1, DE 196 49 728 A1, DE 196 49 729 A1 and DE 198 20 858 A1. Because of the intermediate carrier of foam material, a small thickness for the adhesive film strip, of below 200 μm, is not possible.

Foamed pressure-sensitive adhesive systems have long been known and are described in the prior art. In principle, polymer foams can be produced in two ways. One way is via the effect of a blowing gas, whether added as such or resulting from a chemical reaction, and a second way is via incorporation of hollow spheres into the material matrix. Foams that have been produced by the latter route are referred to as syntactic foams.

Compositions foamed with hollow microspheres are notable for a defined cell structure with a homogeneous size distribution of the foam cells. With hollow microspheres, closed-cell foams without voids are obtained, the features of which include better sealing action against dust and liquid media compared to open-cell variants. Furthermore, chemically or physically foamed materials have a greater propensity to irreversible collapse under pressure and temperature, and frequently show lower cohesive strength. Particularly advantageous properties can be achieved when the microspheres used for foaming are expandable microspheres (also referred to as “microballoons”). By virtue of their flexible, thermoplastic polymer shell, foams of this kind have higher capacity to conform than those filled with nonexpandable, nonpolymeric hollow microspheres (for example, hollow glass spheres). They have better suitability for compensation for manufacturing tolerances, as is the rule, for example, in the case of injection-molded parts, and can also better compensate for thermal stresses because of their foam character. Furthermore, it is possible to further influence the mechanical properties of the foam via the selection of the thermoplastic resin of the polymer shell. For example, even when the foam has a lower density than the matrix, it is still possible to produce foams having higher cohesive strength than with the polymer matrix alone. For instance, typical foam properties such as the capacity to conform to rough surfaces can be combined with a high cohesive strength for pressure-sensitive adhesive foams.

EP 0 257 984 A1 discloses adhesive tapes which at least on one side have a foamed adhesive coating. Contained within this adhesive coating are polymer spheres which in turn comprise a hydrocarbon liquid and which expand at elevated temperatures. The scaffold polymers of the pressure-sensitive adhesives may consist of rubbers or polyacrylates. The microballoons here are added either before or after the polymerization. The microballoons of pressure-sensitive adhesives are processed from solvent and shaped to form adhesive tapes. The step of foaming takes place logically after the coating operation. In this way, micro-rough surfaces are obtained. This results in properties such as, in particular, repositionability. The effect of better repositionability by means of micro-rough surfaces of pressure-sensitive adhesives foamed using microballoons is also described in other specifications such as DE 35 37 433 A1 or WO 95/31225 A1. The micro-rough surface is used in order to produce bubble-free bonding. The same use is also disclosed by EP 0 693 097 A1 and WO 98/18878 A1. Pressure-sensitive adhesives foamed using microballoons are also known from specifications US 4,885,170 A and EP 1 102 809 B, where they are employed, however, as a filler for adhesive tapes for permanent bonding which are not redetachable.

Among the devices in the consumer electronics industry are electronic, optical and precision devices, in the context of this application especially those devices as classified in Class 9 of the International Classification of Goods and Services for the Registration of Marks (Nice classification); 10th edition (NCL(10-2013)), to the extent that these are electronic, optical or precision devices, and also clocks, watches and chronometers according to Class 14 (NCL(10-2013)), such as, in particular,
scientific, marine, measurement, photographic, film, optical, weighing, measuring, signaling, monitoring, rescuing, and instruction apparatus and instruments;
apparatus and instruments for conducting, switching, converting, storing, regulating and monitoring electricity;
image recording, processing, transmission, and reproduction devices, such as televisions and the like;
acoustic recording, processing, transmission, and reproduction devices, such as broadcasting devices and the like;
computers, calculating instruments and data-processing devices, mathematical devices and instruments, computer accessories, office instruments—for example, printers, fax machines, copiers, typewriters-, data-storage devices;
telecommunications devices and multifunction devices with a telecommunications function, such as telephones and answering machines;
chemical and physical measuring devices, control devices, and instruments, such as battery chargers, multimeters, lamps, and tachometers;
nautical devices and instruments;
optical devices and instruments;
medical devices and instruments and those for sportspeople;
clocks, watches and chronometers;
solar cell modules, such as electrochemical dye solar cells, organic solar cells, and thin-film cells; and
fire-extinguishing equipment.

Technical development is going increasingly in the direction of devices which are ever smaller and lighter in design, allowing them to be carried at all times by their owner, and usually being generally carried. This is now accomplished increasingly by realization of low weights and/or suitable size of such devices. Such devices are also referred to as mobile devices or portable devices for the purposes of this specification. In this development trend, precision and optical devices are increasingly being provided (also) with electronic components, thereby raising the possibilities for minimization. On account of the carrying of the mobile devices, they are subject to increased loads—in particular, to mechanical loads—as for instance by impact on edges, by being dropped, by contact with other hard objects in a bag, or else simply by the permanent motion involved in being carried per se. Mobile devices, however, are also subject to a greater extent to loads due to moisture exposure, temperature influences, and the like, than those “immobile” devices which are usually installed in interiors and which move little or not at all.

The invention accordingly refers with particular preference to mobile devices, since the pressure-sensitive adhesive strip used in accordance with the invention has a particular benefit here on account of its unexpectedly good properties (very high shock resistance, low susceptibility to tearing during extensive stretching, i.e., low susceptibility to tears). Listed below are a number of portable devices, without wishing the representatives specifically identified in this list to impose any unnecessary restriction with regard to the subject-matter of the invention.
Cameras, digital cameras, photography accessories (such as light meters, flashguns, diaphragms, camera casings, lenses, etc.), film cameras, video cameras,
small computers (mobile computers, handheld computers, handheld calculators), laptops, notebooks, netbooks, ultrabooks, tablet computers, handhelds, electronic diaries and organizers (called “electronic organizers” or “personal digital assistants”, PDAs, palmtops), modems,
computer accessories and operating units for electronic devices, such as mice, drawing pads, graphics tablets, microphones, loudspeakers, games consoles, gamepads, remote controls, remote operating devices, touchpads,
monitors, displays, screens, touch-sensitive screens (sensor screens, touchscreen devices), projectors,
reading devices for electronic books (“e-books”),
mini TVs, pocket TVs, devices for playing films, video players,
radios (including mini and pocket radios), Walkmans, Discmans, music players for e.g. CDs, DVDs, Blu-ray, cassettes, USB, MP3, headphones,
cordless telephones, mobile phones, smartphones, two-way radios, hands-free telephones, devices for summoning people (pagers, bleepers),
mobile defibrillators, blood sugar meters, blood pressure monitors, step counters, pulse meters,
torches, laser pointers,
mobile detectors, optical magnifiers, binoculars, night vision devices,
GPS devices, navigation devices, portable interface devices for satellite communications,
data storage devices (USB sticks, external hard drives, memory cards),
wristwatches, digital watches, pocket watches, chain watches, stopwatches.

For these devices, a particular requirement is for adhesive tapes that are removable easily as and when desired. In addition, it is important that the holding power of the adhesive tapes does not fail, especially when the electronic device, for example a cellphone, is dropped and hits the ground. The adhesive strip must thus have high shock resistance. DE 10 2015 206 076 A1 describes a pressure-sensitive adhesive strip of this kind with reduced detachment force and high shock resistance, which is redetachable without residue or destruction by extensive stretching substantially in the plane of the bond, which comprises one or more layers of pressure-sensitive adhesive, all of which consist of a pressure-sensitive adhesive which is foamed with microballoons and is constructed in particular on the basis of vinylaromatic block copolymers and tackifier resins, and which optionally consists of one or more intermediate carrier layers, with the pressure-sensitive adhesive strip consisting exclusively of the stated layers of adhesive and of intermediate carrier layers optionally present, and which an outer upper and an outer lower face of the pressure-sensitive adhesive strip are formed by the stated layer or layers of adhesive.

DE 10 2012 223 670 A1 relates to a pressure-sensitive adhesive film strip composed of at least two, more particularly three layers, which is redetachable by extensive stretching substantially in the plane of the bond, which has a carrier bearing on at least one side a first, outer layer of adhesive, the layer of adhesive consisting of an adhesive which is constructed on the basis of vinylaromatic block copolymers and tackifier resins, where to an extent of at least 75% (based on the total resin fraction) a resin is selected which has a DACP (diacetone alcohol cloud point) of greater than −20° C., preferably greater than 0° C., and the carrier has at least one layer which consists of a polyurethane with an elongation at break of at least 100% and a resilience of above 50%. The carrier is therefore highly extensible and to a large extent elastic. Furthermore, large parts of the tackifier resin are unable to migrate from the adhesive layer into the carrier, with positive consequences for the holding power.

DE 10 2015 215 247 A1 relates to a pressure-sensitive adhesive whose base polymer comprises at least one or more solid acrylonitrile-butadiene rubbers and also tackifier resins, with the fraction of the tackifier resins being 30 to 130 phr, characterized in that the acrylonitrile content in the solid acrylonitrile-butadiene rubber(s) is between 10 and 30 wt %. The pressure-sensitive adhesive is cost-reduced and does not lose any peel adhesion even after prolonged storage in various media.

A problem of the strippable pressure-sensitive adhesive tapes from the prior art, however, is that especially when pulled off at an angle of more than 45° with respect to the bond plane, such as 90° with respect to the bond plane, for example, they frequently tear. Detachment is then generally no longer possible, since the remnant of the adhesive strip springs back into the joint and hence a grip tab is no longer available. This is the case, for example, with the customarily employed adhesives based on vinylaromatic block copolymer, even when they are used in an assembly with polyurethane carriers onto which they have been coated. However, particularly in mobile devices such as mobile telephones, for example, there is increasingly less space available when pulling off the strippable pressure-sensitive adhesive tapes, and so there is a demand for strippable pressure-sensitive adhesive tapes which can be pulled off even at an angle of more than 45°, such as 90°, for example, with respect to the bond plane, without tearing. An example is the use of such strippable pressure-sensitive adhesive tapes in battery mounting. Furthermore, there is a demand for strippable pressure-sensitive adhesive tapes whose shock resistance is further improved.

It is an object of the present invention, therefore, to provide a pressure-sensitive adhesive strip which can be redetached without residue or destruction by extensive stretching, i.e., pulling, at an angle of more than 45°, such as of 90°, for example, relative to the bond plane. A particular aim is to reduce the susceptibility to tears, i.e., the frequency of tearing of the adhesive strip, during extensive stretching at an angle of more than 45°, such as of 90°, for example, relative to the bond plane. The pressure-sensitive adhesive strip, furthermore, is typically to exhibit improved shock resistance.

The object is achieved by means of a pressure-sensitive adhesive strip as disclosed herein, i.e., by a pressure-sensitive adhesive strip comprising a carrier and a layer HS1 of pressure-sensitive adhesive that is disposed on one of the surfaces of the carrier, where (i) the carrier in the longitudinal direction and/or the transverse direction, more particularly in the longitudinal direction and the transverse direction, has an elongation at break of at least 250% and (ii) the layer HS1 of pressure-sensitive adhesive consists of a pressure-sensitive adhesive which comprises as base polymer at least one solid acrylonitrile-butadiene rubber and further comprises at least one tackifier resin, with the fraction of tackifier resin totaling 30 to 130 phr.

Surprisingly it has been found that in the pressure-sensitive adhesive strip of the invention, the combination of a layer of pressure-sensitive adhesive based on solid acrylonitrile-butadiene rubber with an extensible carrier, i.e., a carrier having an elongation at break at least in the pull-off direction—which may be the longitudinal direction and/or the transverse direction of the carrier—of at least 250%, leads to a reduced susceptibility to tears during extensive stretching, especially during extensive stretching at an angle of more than 45°, such as of 90°, for example, relative to the bond plane. The pressure-sensitive adhesive strip of the invention can be redetached without residue or destruction, in particular with no more than low susceptibility to tearing, by extensive stretching at different angles relative to the bond plane. Conceivable angles are, for example, 0°, i.e., essentially in the bond plane, or more than 45°, such as 90°, for example, relative to the bond plane. On extensive stretching at different angles, such as 0° or more than 45°, for example, the pressure-sensitive adhesive strip is also very easy to detach without residue; apparently, therefore, there is a distinct drop in the tack of the pressure-sensitive adhesive strip of the invention in the course of extensive stretching. Furthermore, the stated combination leads to improved shock resistance on the part of the resultant pressure-sensitive adhesive strip, typically not only in the x,y-plane, also called transverse impact strength, but also in the z-plane, also called penetrative impact strength. The pressure-sensitive adhesive strips of the invention, furthermore, typically exhibit high peel adhesions.

Also disclosed are advantageous embodiments of the pressure-sensitive adhesive strip.

Liquid rubbers are distinguished relative to solid rubbers in that they have a softening point Tₛ of less than 40° C. Solid rubbers are therefore characterized in that they do not have a softening point Tₛ of less than 40° C. The data for the softening point Tₛ of oligomeric compounds, polymeric compounds, and resins are based on the ring and ball method of DIN EN 1427:2007, with appropriate application of the provisions (investigation of the oligomer, polymer or resin sample instead of bitumen, with the procedure otherwise retained); the measurements are made in a glycerol bath.

If the fraction of tackifier resin in the layer HS1 of pressure-sensitive adhesive totals 30 to 130 phr, then the layer of pressure-sensitive adhesive is characterized in particular simultaneously by good values for adhesion and for cohesion.

The term “tackifier resin” is understood by the skilled person to refer to a resin-based substance which increases the tack. For the purposes of the present patent application, tackifier resins are not considered to be polymers.

The data given in the present patent application in phr (for “parts per hundred rubber”) each denote parts by weight of the relevant component per 100 parts by weight of all of the solid rubber components of the pressure-sensitive adhesive—the PSA—and hence do not take account, for example, of tackifier resin or liquid rubber.

In the pressure-sensitive adhesive strip of the invention, disposed on the surface of the carrier that is opposite the layer HS1 of pressure-sensitive adhesive (PSA), there is a layer HS2 of pressure-sensitive adhesive (PSA). The PSA layer HS2 consists preferably, like the PSA layer HS1 before it, likewise of a PSA which comprises as base polymer at least one solid acrylonitrile-butadiene rubber and further comprises at least one tackifier resin, with the fraction of tackifier resin totaling 30 to 130 phr. With particular preference the PSA layers HS1 and HS2 have an identical composition.

The concept of a PSA layer HS1 or HS2 being “disposed” on one of the surfaces of a carrier may in the present patent application refer to a disposition such that the respective PSA layer is in direct contact with the surface of the carrier, i.e., is disposed directly on the surface. Alternatively such a disposition may mean that there is at least one further layer present between the PSA layer HS1 or HS2 and the surface of the carrier, said layer not opposing the residue-free and nondestructive detachability of the pressure-sensitive adhesive strip by extensive stretching, more particularly at an angle of more than 45° with respect to the bond plane. Preferably, in the pressure-sensitive adhesive strip of the invention, the PSA layers HS1 and/or HS2, and more particularly the PSA layers HS1 and HS2, are in direct contact with respectively one of the two surfaces of the carrier.

Preferably, in the pressure-sensitive adhesive strip of the invention, the PSA layers HS1 and/or HS2, more particularly the PSA layers HS1 and HS2, are outer PSA layers. This means that the pressure-sensitive adhesive strip preferably has an upper outer and a lower outer face, with the upper outer and the lower outer face not bearing one or more further layers, more particularly no other layers of adhesive, which are part of the pressure-sensitive adhesive strip. Before being used, the pressure-sensitive adhesive strip may be covered in with a liner on one or both sides. In accordance with the present patent application, a liner (release paper, release film) is not a constituent of a pressure-sensitive adhesive strip, but instead only an aid to its production, storage, or for onward processing by die cutting. Furthermore, in contrast to the carrier having an elongation at break of at least 250% that is contained in the pressure-sensitive adhesive strip of the invention, a liner is not firmly joined to a layer of adhesive.

The PSA layer HS1 based on solid acrylonitrile-butadiene rubber, and, if present in the pressure-sensitive adhesive strip of the invention, the PSA layer HS2 based on solid acrylonitrile-butadiene rubber, are preferably outer PSA layers. In a pressure-sensitive adhesive strip of this kind, the advantage observed in accordance with the invention, namely the high shock resistance, typically both in the x,y-plane and in the z-plane, can be realized to particularly good effect.

In the context of the present patent application, a PSA layer based on solid acrylonitrile-butadiene rubber means a PSA layer which consists of a PSA which comprises as base polymer at least one solid acrylonitrile-butadiene rubber and further comprises at least one tackifier resin, with the fraction of tackifier resin totaling 30 to 130 phr. Additionally, a PSA based on solid acrylonitrile-butadiene rubber means a PSA which comprises as base polymer at least one solid acrylonitrile-butadiene rubber and further comprises at least one tackifier resin, with the fraction of tackifier resin totaling 30 to 130 phr.

In one particularly preferred embodiment, the pressure-sensitive adhesive strip of the invention consists exclusively of a carrier having an elongation at break in the longitudinal direction and/or the transverse direction, more particularly in the longitudinal direction and the transverse direction, of at least 250% and

of a PSA layer HS1 which is disposed on one of the surfaces of the carrier and consists of a PSA which comprises as base polymer at least one solid acrylonitrile-butadiene rubber and further comprises at least one tackifier resin, with the fraction of tackifier resin totaling 30 to 130 phr,

and optionally further of a PSA layer HS2 which is disposed on the surface of the carrier opposite the PSA layer HS1 and which likewise consists of a PSA which comprises as base polymer at least one solid acrylonitrile-butadiene rubber and further comprises at least one tackifier resin, with the fraction of tackifier resin totaling 30 to 130 phr.

These single-sided and double-sided adhesive tapes are characterized by at most low tear susceptibilities even on removal at an angle of more than 45° relative to the bond plane, and additionally have outstanding shock resistances, i.e., transverse impact strengths and penetrative impact strengths. With more particular preference here the double-sided adhesive tape is as described above. Adhesive tapes in the sense of the present patent application are understood to be sheetlike or tapelike carrier structures coated on one or both sides with adhesive, hence including not only conventional tapes but also labels, sections, die cuts (punched, adhesive-coated, sheetlike carrier structures), two-dimensionally extended structures (film, for example), and the like, including multilayer arrangements.

The acrylonitrile content in the solid acrylonitrile-butadiene rubber of the PSA layer HS1 and/or HS2 is preferably between 10 and 45 wt %, more preferably between 10 and 30 wt %, more preferably still between 10 and 25 wt %, and more particularly between 15 and 20 wt %. In these ranges it is possible to achieve particularly low tear susceptibilities and particularly high shock resistances. The fraction of solid acrylonitrile-butadiene rubber in the PSA based on solid acrylonitrile-butadiene rubber of the PSA layer HS1 and/or HS2 totals preferably at least 50 wt %, based on the total weight of the PSA.

In the PSA based on solid acrylonitrile-butadiene rubber of the PSA layer HS1 and/or HS2 of the pressure-sensitive adhesive strip of the invention, there may preferably be, as further base polymer, at least one liquid acrylonitrile-butadiene rubber, with the acrylonitrile content in the at least one liquid acrylonitrile-butadiene rubber being preferably between 10 and 45 wt %, more preferably between 10 and 30 wt %, more preferably still between 10 and 25 wt %, and more particularly between 15 and 20 wt %. The fraction of liquid acrylonitrile-butadiene rubber in the PSA based on solid acrylonitrile-butadiene rubber of the PSA layer HS1 and/or HS2 totals preferably up to 20 wt %, more preferably between 1 and 15 wt %, and more particularly between 2 and 10 wt %, based in each case on the total weight of the PSA.

In the PSA based on solid acrylonitrile-butadiene rubber of the PSA layer HS1 and/or HS2, the base polymer preferably consists of solid acrylonitrile-butadiene rubber or of liquid and solid acrylonitrile-butadiene rubber, there being more preferably no polymer other than the acrylonitrile-butadiene rubber in the PSA. Alternatively the base polymer comprises to an extent of more than 90 wt %, preferably more than 95 wt %, solid and optionally liquid acrylonitrile-butadiene rubber.

In a further preferred embodiment in the PSA based on solid acrylonitrile-butadiene rubber of the PSA layer HS1 and/or HS2 of the pressure-sensitive adhesive strip of the invention, there is a blend of at least three synthetic nitrile rubbers S1, S2, and S3, where
(a) the blend is microphase-separated, characterized by at least three different glass transition temperatures in the DSC,
(b) at least one glass transition temperature is greater than 10° C. and one glass transition temperature is less than -20° C.,
(c) the nitrile rubber or rubbers S1 has/have an acrylonitrile fraction of greater than or equal to 35 wt %,
(d) the nitrile rubber or rubbers S2 has/have an acrylonitrile fraction of greater than 25 wt % and less than 35 wt %, and
(e) the nitrile rubber or rubbers S3 has/have an acrylonitrile fraction of less than or equal to 25 wt %.

As a result of the domains with the low glass transition temperature, the low-temperature impact strength and the adhesion at low temperatures are increased; as a result of the domains with the high glass transition temperature, the bond strength at high temperatures and the dimensional stability of the die cuts under pressure and under temperature are obtained.

In the PSA layer HS1 and/or HS2 which comprises such a blend of at least three synthetic nitrile rubbers S1, S2, and S3, the weight fraction of the nitrile rubber or rubbers S1 is preferably between 5 and 50 wt %, based on the total nitrile rubber fraction; the weight fraction of the nitrile rubber or rubbers S2 is preferably between 10 and 90 wt %, based on the total nitrile rubber fraction; and the weight fraction of the nitrile rubber or rubbers S3 is preferably between 5 and 50 wt %, based on the total nitrile rubber fraction.

### Nitrile Rubbers S1

Nitrile-butadiene rubbers are available as Europrene™ from Eni Chem, or as Krynac™ and Perbunan™ from Bayer, or as Breon™ and Nipol N™ from Zeon. Hydrogenated nitrile-butadiene rubbers are available as Therban™ from Bayer and as Zetpol™ from Zeon. Nitrile-butadiene rubbers are polymerized either hot or cold. The nitrile rubbers S1 have an acrylonitrile fraction of greater than 35 wt %. In order to avoid complete phase separation, however, the acrylonitrile fraction ought to be less than 60 wt %, in turn based on the total fraction of S1. Further criterion is the glass transition temperature of the nitrile rubbers S1. In order to achieve microphase separation, in one preferred version the static glass transition temperature in the DSC ought to be greater than or equal to −20° C., more preferably greater than −15° C. A further criterion for the nitrile rubber S1 is the Mooney viscosity. Since it is necessary to ensure a high flexibility at low temperatures, this criterion ought to be below 120 (Mooney ML 1+4 at 100° C., according to DIN 53523). Commercial examples of such nitrile rubbers are, for example, Nipol™ 40-5 from Zeon Chemicals.

### Nitrile Rubbers S2

Nitrile-butadiene rubbers are available as Europrene™ from Eni Chem, or as Krynac™ and Perbunan™ from Bayer, or as Breon™ and Nipol N™ from Zeon. Hydrogenated nitrile-butadiene rubbers are available as Therban™ from Bayer and as Zetpol™ from Zeon. Nitrile-butadiene rubbers are polymerized either hot or cold. The nitrile rubbers S2 have an acrylonitrile fraction of less than 35 wt % and greater than 25 wt %. Further criterion is the glass transition temperature of the nitrile rubbers S2. In order to achieve microphase separation, in one preferred version the static glass transition temperature in the DSC ought to be less than −20° C., more preferably less than −25° C. A further criterion for the nitrile rubber S2 is the Mooney viscosity. Since it is necessary to ensure a high flexibility at low temperatures, this criterion ought to be below 100 (Mooney ML 1+4 at 100° C., according to DIN 53523). Commercial examples of such nitrile rubbers are, for example, Breon™ N33C50 from Zeon Chemicals.

### Nitrile Rubbers S3

Nitrile-butadiene rubbers are available as Europrene™ from Eni Chem, or as Krynac™ and Perbunan™ from Bayer, or as Breon™ and Nipol N™ from Zeon. Hydrogenated nitrile-butadiene rubbers are available as Therban™ from Bayer and as Zetpol™ from Zeon. Nitrile-butadiene rubbers are polymerized either hot or cold. The nitrile rubbers S3 have an acrylonitrile fraction of less than 25 wt %. In order to avoid complete phase separation, however, the acrylonitrile fraction ought to be greater than 4 wt %, in turn based on the total fraction of S3. Further criterion is the glass transition temperature of the nitrile rubbers S3. In order to achieve microphase separation, in one preferred version the static glass transition temperature in the DSC ought to be less than or equal to −35° C., more preferably less than −40° C. A further criterion for the nitrile rubber S3 is the Mooney viscosity. Since it is necessary to ensure a high flexibility at low temperatures, this criterion ought to be below 100 (Mooney ML 1+4 at 100° C., according to DIN 53523). Commercial examples of such nitrile rubbers are, for example, Nipol™ 1034-60 from Zeon Chemicals.

In the PSA based on solid acrylonitrile-butadiene rubber of the PSA layer HS1 and/or HS2, the acrylonitrile-butadiene rubber may, in order to improve the processing properties, be admixed with thermoplastic elastomers such as, for example, synthetic rubbers, with a fraction of up to 5 wt %, based on the total weight of the PSA. Representatives that may be mentioned at this point include in particular the especially compatible styrene-isoprene-styrene (SIS) and styrene-butadiene-styrene (SBS) types.

In one particularly preferred embodiment, the PSA based on solid acrylonitrile-butadiene rubber of the PSA layer HS1 and/or HS2 is a composition of solid and liquid acrylonitrile-butadiene rubber, one or more tackifier resins, preferably aging inhibitor(s), and optionally release assistants. Furthermore it is possible optionally for plasticizers, fillers and/or dyes to be present additionally, typically in small amounts.

The acrylonitrile-butadiene rubbers may have been admixed with inert release assistants such as talc, silicates (talc, clay, mica), zinc stearate, and PVC powders, more particularly in an order of magnitude of 3 phr.

In the PSA based on solid acrylonitrile-butadiene rubber of the PSA layer HS1 and/or HS2, the fraction of tackifier resin totals preferably 40 to 120 phr, more preferably 50 to 110 phr, and more particularly 60 to 100 phr. In this way it is possible typically to achieve particularly good adhesion and cohesion values simultaneously.

As tackifier resins it is possible, in the PSA layer HS1 and/or HS2 of the pressure-sensitive adhesive strip of the invention, to use, in particular, hydrogenated and nonhydrogenated hydrocarbon resins and polyterpene resins. Of preferential suitability among others are hydrogenated polymers of dicyclopentadiene (for example, Escorez 5300er series; Exxon Chemicals), hydrogenated polymers of preferably C8 and C9 aromatics (for example, Regalite and Regalrez series; Eastman Inc., or Arkon P series; Arakawa). These resins may arise through hydrogenation of polymers from pure aromatic streams or else by hydrogenation of polymers based on mixtures of different aromatics. Also suitable are partially hydrogenated polymers of C8 and C9 aromatics (for example, Regalite and Regalrez series; Eastman Inc., or Arkon M; Arakawa), hydrogenated polyterpene resins (for example, Clearon M; Yasuhara), hydrogenated C₅/C₉ polymers (for example, ECR-373; Exxon Chemicals), aromatic-modified, selectively hydrogenated dicyclopentadiene derivates (for example, Escorez 5600er series; Exxon Chemicals). The aforesaid tackifier resins may be used both alone and in a mixture.

Hydrogenated hydrocarbon resins are particularly suitable as a blend component, as described for example in 04478554133731482074628455411980660994/1117595/2577497/07963, 04478554133731482074628455411980660994/1117595/2577497/07963 and 04478554133731482074628455411980660994/1117595/2577497/07963, since the absence of double bonds means that the crosslinking cannot be disrupted.

Furthermore, however, nonhydrogenated resins can also be used, if crosslinking promoters are employed such as, for example, polyfunctional acrylates.

Other nonhydrogenated hydrocarbon resins, nonhydrogenated analogs of the hydrogenated resins described above, may also be used.

It is possible, furthermore, to use rosin-based resins (for example, Foral, Foralyn).

The abovementioned rosin resins include, for example, natural rosin, polymerized rosin, partially hydrogenated rosin, fully hydrogenated rosin, esterified products of these kinds of rosin (such as glycerol esters, pentaerythritol esters, ethylene glycol esters, and methyl esters), and rosin derivatives (such as disproportionation rosin, fumaric acid-modified rosin, and lime-modified rosin).

The tackifier resins are optionally polyterprene resins based on α-pinene and/or β-pinene and/or δ-limone or terpene-phenolic resins.

Any desired combinations of these may be used in order to adjust the properties of the resultant PSA in accordance with requirements. Reference may expressly be made to the representation of the state of knowledge in “Handbook of Pressure Sensitive Adhesive Technology” by Donatas Satas (van Nostrand, 1989).

Resins employed with particular preference are terpene-phenolic resins and/or polyterpenes, and especially terpene-phenolic resins, examples being terpene-phenolic resins like those sold by DRT under the trade name Dertophene or by Arizona under the trade name Sylvares.

In order to adjust optical and technical adhesive properties, the PSA of the PSA layer HS1 and/or HS2 may comprise additives such as fillers, dyes or aging inhibitors (antiozonants, antioxidants (primary and secondary), light stabilizers, etc.).

Additives typically utilized are as follows:
primary antioxidants such as, for example, sterically hindered phenols
secondary antioxidants such as, for example, phosphites or thioethers,
light stabilizers such as, for example, UV absorbers or sterically hindered amines.

The fillers may be reinforcing or nonreinforcing. Particularly noteworthy here are silicon dioxides (spherical, acicular or irregular like the fumed silicas), phyllosilicates, calcium carbonates, zinc oxides, titanium dioxides, aluminum oxides, or aluminum oxyhydroxides.

The concentration of the additives influencing optical and technical adhesive properties is preferably up to 20 wt %, more preferably up to 15 wt %, and more particularly up to 5 wt %, based in each case on the total weight of the PSA.

In a PSA employed in accordance with the invention and based on solid acrylonitrile-butadiene rubber of the PSA layer HS1 and/or HS2, the fractions of all added substances (besides acrylonitrile-butadiene rubber and tackifier resin), such as, for example, synthetic rubbers and/or thermoplastic elastomers and/or fillers and/or dies and/or aging inhibitors, ought in accordance with the invention to not exceed preferably in total 5 wt %, more preferably 2 wt %, based in each case on the total weight of the PSA. The listed substances are present not mandatorily but instead only optionally in the PSA; in other words, the PSA functions even without the addition of these substances individually or in any desired combination, thus without synthetic rubbers and/or elastomers and/or fillers and/or dies and/or aging inhibitors.

According to one preferred embodiment, the PSA layer HS1 and/or HS2 of the pressure-sensitive adhesive strip of the invention is foamed, with the possible and typical consequence of a further improvement in particular in shock resistances. The foaming is accomplished in particular through the introduction and subsequent expansion of microballoons.

“Microballoons” are understood in accordance with the invention to be hollow microspheres which are elastic and therefore expandable in their basic state, with a thermoplastic polymer shell. These spheres are filled with low-boiling liquids or liquefied gas. Shell material used is, in particular, polyacrylonitrile, PVDC, PVC or polyacrylates. Suitability as low-boiling liquid is possessed in particular by hydrocarbons of the lower alkanes, as for example by isobutane or isopentane, which are enclosed in the form of liquefied gas under pressure in the polymer shell.

Exposure of the microballoons, particularly exposure to heat, causes the outer polymer shell to soften. At the same time, the liquid blowing gas present within the shell undergoes transition into its gaseous state. In this case the microballoons undergo irreversible enlargement and expand three-dimensionally. Expansion is at an end when the internal and external pressures are the same. Since the polymeric shell is retained, the result is a closed-cell foam.

A multiplicity of types of microballoon are available commercially, differing essentially in their size (6 to 45 μm in diameter in the unexpanded state) and the onset temperatures required for their expansion (75 to 220° C.). An example of commercially available microballoons are the Expancel® DU products (DU=dry unexpanded) from Akzo Nobel.

Unexpanded types of microballoon are also available in the form of an aqueous dispersion having a solids fraction or microballoon fraction of around 40 to 45 wt %, and additionally in the form of polymer-bound microballoons (masterbatches), in ethylvinyl acetate, for example, with a microballoon concentration of around 65 wt %. Like the DU products, both the microballoon dispersions and the masterbatches are suitable for producing a foamed PSA layer HS1 and/or HS2.

A foamed PSA layer HS1 and/or HS2 may alternatively be generated with what are called pre-expanded microballoons as well. With this group, the expansion occurs even prior to incorporation into the polymer matrix. Pre-expanded microballoons are available commercially, for example, under the designation Dualite® or with the product designation Expancel xxx DE (dry expanded) from Akzo Nobel.

Where microballoons are employed in a PSA used in accordance with the invention, the average diameter of the cavities formed by the microballoons in the PSA layer HS1 and/or HS2 is typically 10 to 200 μm, such as, for example, 20 to 50 μm or 60 to 100 μm. The average diameter of the cavities formed by the microballoons in a PSA layer is determined on the basis of cryofracture edges of the pressure-sensitive adhesive strip under a scanning electron microscope (SEM) at 500-times magnification. The diameter of each of the microballoons in the PSA layer under investigation that are visible on SEM micrographs of 5 different cryofracture edges of the pressure-sensitive adhesive strip is ascertained graphically, with the arithmetic mean of all ascertained diameters representing the average diameter of the cavities of the PSA layer that are formed by the microballoons, in the sense of the present patent application. Ascertaining the diameters of the microballoons visible on the micrographs graphically is done by taking the maximum enlargement in any (two-dimensional) direction for each individual microballoon in the PSA layer under investigation, from the SEM micrographs, and regarding that maximum enlargement as the diameter of said microballoon.

Where foaming takes place by means of microballoons, the microballoons may be supplied as a batch, a paste or an unextended or extended powder to the formulation. They may also be present in suspension in solvent.

The proportion of the microballoons in the PSA of the PSA layer HS1 and/or HS2, according to one preferred embodiment of the invention, is between greater than 0 wt % and 10 wt %, more preferably between 0.25 wt % and 5 wt %, and more particularly between 0.5 and 1.5 wt %, based in each case on the total weight of the PSA. Within these ranges it is possible to provide pressure-sensitive adhesive strips which customarily exhibit particularly high shock resistances.

A polymer composition of the invention that comprises expandable hollow microspheres may also, additionally, comprise nonexpandable hollow microspheres. All that is crucial is that virtually all gas-containing caverns are closed by a permanently impervious membrane, no matter whether this membrane consists of an elastic and thermoplastically extensible polymer mixture or, for instance, of elastic and—within the spectrum of the temperatures possible in plastics processing—nonthermoplastic glass.

Also suitable for the PSA layers HS1 and/or HS2—selected independently of other additives—are solid polymer spheres, hollow glass spheres, solid glass spheres, hollow ceramic spheres, solid ceramic spheres and/or solid carbon spheres (“carbon microballoons”).

The absolute density of a foamed PSA of the invention is preferably 350 to 990 kg/m³, more preferably 450 to 970 kg/m³, more particularly 500 to 900 kg/m³. The relative density describes the ratio of the density of the foamed PSA of the invention to the density of the unfoamed PSA of the invention whose formula is identical. The relative density of a foamed PSA of the invention is preferably 0.35 to 0.99, more preferably 0.45 to 0.97, more particularly 0.50 to 0.90.

In a further preferred embodiment of the pressure-sensitive adhesive strip of the invention, disposed on the carrier surface opposite the PSA layer HS1 is a PSA layer HS2 which consists of a PSA whose base polymer consists exclusively of polymer which is different from acrylonitrile-butadiene rubber, with the PSA comprising as its base polymer preferably at least one vinylaromatic block copolymer. With particular preference, in the PSA of a PSA layer HS2, the base polymer consists exclusively of vinylaromatic block copolymer, with no polymer other than the vinylaromatic block copolymer being present in the PSA, more particularly. The PSA based on vinylaromatic block copolymer of the PSA layer HS2 customarily further comprises at least one tackifier resin, particularly in order to increase the adhesion in a desired way. The tackifier resin ought to be compatible with the elastomer block of the block copolymers. With preference as well at least the PSA layer HS1, and more preferably, furthermore, the PSA layer HS2 as well, is an outer PSA layer. With particular preference the pressure-sensitive adhesive strip consists exclusively of an extensible carrier, i.e., a carrier having an elongation at break of at least 250%, a PSA layer HS1 based on solid acrylonitrile-butadiene rubber, and a PSA layer HS2 consisting of a PSA whose base polymer consists exclusively of polymer which is different from acrylonitrile-butadiene rubber, with the PSA comprising as its base polymer preferably at least one vinylaromatic block copolymer.

The vinylaromatic block copolymer preferably comprises polymer blocks (i) predominantly formed of vinylaromatics (A blocks), preferably styrene, and at the same time (ii) blocks predominantly formed by polymerization of 1,3-dienes (B blocks), such as, for example, butadiene and isoprene, or a copolymer of both. Preferably as well, the vinylaromatic block copolymer used comprises at least one synthetic rubber in the form of a block copolymer having an A-B, A-B-A, (A-B)ₙ, (A-B)ₙX or (A-B-A)ₙX structure, in which
the blocks A independently of one another are a polymer formed by polymerization of at least one vinylaromatic,
the blocks B independently of one another are a polymer formed by polymerization of conjugated dienes having 4 to 18 carbon atoms, or are a partly hydrogenated derivative of such a polymer,
X is the radical of a coupling reagent or initiator, and
n is an integer 2.

The vinylaromatics for constructing the block A comprise preferably styrene, α-methylstyrene and/or other styrene derivatives, more preferably styrene. The monomer for the block B is further preferably selected from the group consisting of butadiene, isoprene, ethylbutadiene, phenylbutadiene, piperylene, pentadiene, hexadiene, ethylhexadiene, and dimethylbutadiene, and also any desired mixtures of these monomers.

The proportion of the vinylaromatic block copolymers, such as especially styrene block copolymers, in total, based on the overall PSA of the PSA layer HS2, is at least 20 wt %, preferably at least 30 wt %, more preferably at least 35 wt %, and at the same time not more than 75 wt %, preferably not more than 65 wt %, very preferably not more than 55 wt %. If the fraction of vinylaromatic block copolymers is too low, a consequence is that the cohesion of the PSA is relatively low. Too high a fraction of vinylaromatic block copolymers, in turn, has the consequence that the PSA is barely still pressure-sensitively adhesive.

If tackifier resin is present in the PSA based on vinylaromatic block copolymer of a PSA layer HS2, the amount of resin present is preferably from 20 to 60 wt % and more preferably from 30 to 50 wt %, based in each case on the total weight of the PSA of the PSA layer HS2.

Tackifier resin selected in the PSA based on vinylaromatic block copolymer of a PSA layer HS2, preferably to an extent of at least 75 wt % (based on the total resin fraction), is a resin having a DACP (diacetone alcohol cloud point) of greater than −20° C., preferably greater than 0° C., the resin more particularly being hydrocarbon resin or terpene resin or a mixture thereof. Nonpolar tackifier resins of this kind exhibit substantially no migration into polar carriers, thus resulting in the PSA layer having a tack which is of long-term stability, and also in the adjacent carrier having a tensile strength which is of long-term stability.

In accordance with the invention the PSA layers HS1 and/or HS2 of the pressure-sensitive adhesive strip of the invention, independently of their composition, have a thickness preferably of 10 to 200 μm, such as, for example, of 20 to 50 μm.

The coatweight of a PSA used in producing a pressure-sensitive adhesive strip of the invention is preferably 10 to 200 g/m², more preferably 15 to 100 g/m², and more particularly 20 to 75 g/m², based on a substantially solvent-free form.

The pressure-sensitive adhesive strip of the invention comprises a stretchable carrier, i.e., a carrier having an elongation at break of at least 250%, with the carrier preferably having an elongation at break of at least 300%, more preferably of at least 400%, and more particularly of at least 500%, such as, for example, of at least 600%. The carrier has the specified elongation-at-break values in the longitudinal direction and/or in the transverse direction, and more particularly in both the longitudinal direction and the transverse direction. The stretchability of a carrier having an elongation at break of at least 250% in the longitudinal direction and/or the transverse direction is sufficient to ensure detachment of the pressure-sensitive adhesive strip of the invention by extensive stretching in the corresponding direction in the case of different removal angles relative to the bond plane, such as 0° or 90°, for example. Serving as carriers for example may be very stretchable films. Examples of stretchable carriers which can be employed advantageously are transparent embodiments from WO 2011/124782 A1, DE 10 2012 223 670 A1, WO 2009/114683 A1, WO 2010/077541 A1, WO 2010/078396 A1.

In the longitudinal direction and/or the transverse direction, more particularly in the longitudinal direction and the transverse direction, the carrier preferably has a resilience of above 50%, more preferably of above 70%, and more particularly above 80%. This means that preferably the elastic fraction of the carrier at least in the longitudinal direction or the transverse direction, more particularly in both the longitudinal direction and the transverse direction, is greater than the plastic fraction.

The thickness of the carrier is preferably in the range from 10 to 200 μm, more preferably from 20 to 150 μm, and more particularly 50 to 100 μm.

In the longitudinal direction and/or the transverse direction, more particularly in the longitudinal direction and the transverse direction, the carrier typically has a 50% elongation stress of less than 20 N/mm², preferably of less than 10 N/mm², in order to permit simple detachment of the pressure-sensitive adhesive strip in the corresponding direction or in the corresponding directions without excessive use of force.

The carrier may be produced using film-forming or extrudable polymers, which may additionally have been monoaxially or biaxially oriented.

One preferred embodiment uses polyurethanes. Polyurethanes are chemically and/or physically crosslinked polycondensates composed typically of polyols and isocyanates. Depending on the nature of the individual components and the proportions in which they are used, stretchable materials are obtainable which can be employed advantageously for the purposes of this invention. Raw materials available to the formulator for this purpose are, for example, specified in EP 0 894 841 B1 and EP 1 308 492 B1. The polyurethane is preferably a polyether urethane or a polyester urethane.

Furthermore, polyolefins can be used advantageously as starting materials for the stretchable carrier. Preferred polyolefins are prepared from ethylene, propylene, butylene and/or hexylene, in which case the pure monomers can be polymerized in each case, or mixtures of the stated monomers are copolymerized. Through the polymerization process and through the selection of the monomers it is possible to control the physical and mechanical properties of the polymer film, such as the softening temperature and/or the tensile strength, for example.

The skilled person is aware of further raw materials from which carriers of the invention may be constructed. It is advantageous, moreover, to employ rubber-based materials in carriers in order to realize the desired stretchability. As rubber or synthetic rubber or blends produced therefrom, as starting material for stretchable carriers, the natural rubber may in principle be selected from all available grades such as, for example, crepe, RSS, ADS, TSR or CV products, depending on the required level of purity and viscosity, and the synthetic rubber or synthetic rubbers may be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes, and/or blends thereof.

Employable with particular advantage as materials for stretchable carriers are block copolymers. Here, individual polymer blocks are linked covalently to one another. The linkage of the blocks may have a linear form, or else a star-shaped or graft copolymer variant. One example of an advantageously employable block copolymer is a linear triblock copolymer whose two terminal blocks have a softening temperature of at least 40° C., preferably at least 70° C., and whose middle block has a softening temperature of at most 0° C., preferably at most −30° C. Higher block copolymers, for instance tetrablock copolymers, are likewise employable. It is important that at least two polymer blocks of the same or different kind are present in the block copolymer, having a softening temperature in each case of at least 40° C., preferably at least 70° C., and separated from one another in the polymer chain by at least one polymer block having a softening temperature of at most 0° C., preferably at most −30° C. Examples of polymer blocks are polyethers such as, for example, polyethylene glycol, polypropylene glycol or polytetrahydrofuran, polydienes, such as, for example polybutadiene or polyisoprene, hydrogenated polydienes, such as, for example, polyethylene-butylene or polyethylene-propylene, polyesters, such as, for example, polyethylene terephthalate, polybutanediol adipate or polyhexanediol adipate, polycarbonate, polycaprolactone, polymer blocks of vinylaromatic monomers, such as, for example, polystyrene or poly-[α]-methylstyrene, polyalkyl vinyl ethers, polyvinyl acetate, polymer blocks of [α],[β]-unsaturated esters such as, in particular, acrylates or methacrylates. The skilled person knows of corresponding softening temperatures. Alternatively this person looks them up in, for example, the Polymer Handbook [J. Brandrup, E. H. Immergut, E. A. Grulke (Eds.), Polymer Handbook, 4th edn. 1999, Wiley, New York]. Polymer blocks may be constructed of copolymers.

To produce a carrier material it may also be appropriate here to add additives and further components which enhance the film-forming properties, which reduce the tendency for crystalline segments to form and/or which specifically improve or else, where appropriate, impair the mechanical properties.

Additionally suitable as carriers are foam materials (made from polyethylene and polyurethane, for example) in web form.

The carriers may have a multilayer design, or single-layer. Preferably the carrier consists only of a single layer.

Furthermore, the carriers may have outer layers, barrier layers for example, which prevent penetration of components from the adhesive into the carrier or vice versa. These outer layers may also have barrier properties so as to prevent diffusion of water vapor and/or oxygen through the layer.

For more effective anchorage of the PSA or PSAs on the carrier, the carrier may be pretreated by the known measures such as corona, plasma or flaming. Also possible is the use of a primer. Ideally, however, there is no need for pretreatment.

The reverse of the carrier may have been subjected to an antiadhesive physical treatment or coating.

Lastly, the pressure-sensitive adhesive strip of the invention may be covered on one or both sides with a liner, in other words with a temporary carrier with antiadhesive coating on both sides. A liner (release paper, release film) is not part of an adhesive tape but instead only an aid to the production or storage thereof or an aid to further processing by die cutting. Furthermore, in contrast to an adhesive tape carrier, a liner is not firmly joined to a layer of adhesive.

Typical processed forms of the pressure-sensitive adhesive strips of the invention are adhesive tape rolls and also adhesive strips of the kind obtained for example in the form of die cuts. All layers preferably have the form, substantially, of a cuboid. With further preference, all the layers are joined to one another over their full area. Optionally there may be a nonadhesive grip tab region provided, starting from which the detachment operation can be performed.

The pressure-sensitive adhesive strip preferably has a thickness of 20 μm to 600 μm, more preferably of 70 μm to 200 μm.

The pressure-sensitive adhesive strips of the invention may be produced by customary methods known to the skilled person. The PSAs may be produced and processed both from solution and from the melt. Application of the PSAs to the carriers may be accomplished by direct coating or by lamination, especially hot lamination. For example, the PSAs, including the additives, in solution in a suitable solvent, may be coated onto carriers by means, for example, of engraved-roller application, bar coating, multiroll coating, or in a printing process, and the solvent can be removed subsequently in a drying tunnel or drying oven. Alternatively, the carriers may also be coated in a solvent-free process. For that purpose, the base polymer is heated and melted in an extruder. Further procedural steps, such as mixing with the additives described, filtration or degassing, may take place within the extruder. The melt is then coated by means of a calender onto the carriers.

The pressure-sensitive adhesive strip of the invention is used preferably for bonding parts in electronic devices, particularly in portable electronic devices such as, for example, tablets, mobile telephones, smart watches, and other wearables. It may be used, for example, to bond batteries. The pressure-sensitive adhesive strip of the invention is very useful in particular for bonding in portable electronic devices in relation to the small amount of space present therein, since even in the case of the extensible stretching that is frequently required there, it can be redetached without residue or destruction, customarily, at an angle of more than 45° relative to the bond surface, without tearing.

With reference to the below-described figures and also examples, particularly advantageous embodiments of the invention are elucidated in more detail, without any intention thereby to subject the invention to unnecessary restriction.

### FIGURES

In the figures

FIG. 1 shows a three-layer pressure-sensitive adhesive strip of the invention and

FIG. 2 shows a three-layer pressure-sensitive adhesive strip of the invention in an alternative embodiment.

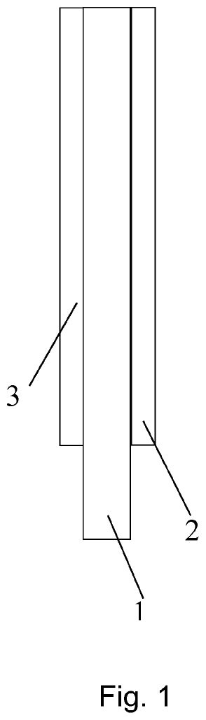

FIG. 1 shows a pressure-sensitive adhesive strip of the invention, composed of three layers 1, 2, 3, which is redetachable without residue or destruction, without tearing, by extensive stretching, at an angle of more than 45° relative to the bond plane, for example. The strip consists of a stretchable carrier 1, i.e., a carrier having an elongation at break of at least 250% in the longitudinal and/or transverse directions, preferably in both the longitudinal and the transverse directions, the carrier 1 being of single-layer embodiment. Present on the carrier on both sides are outer layers 2, 3 of adhesive that can be used in accordance with the invention. The protruding end of the carrier layer 1 may serve as a grip tab, but is not mandatorily present.

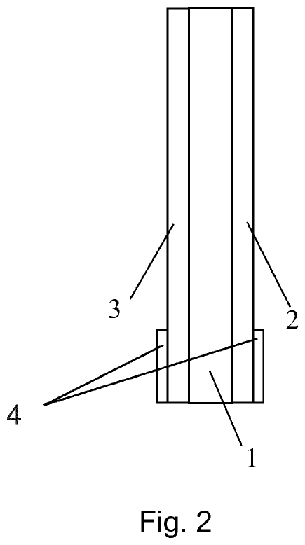

FIG. 2 shows the pressure-sensitive adhesive strip of the invention in an alternative variant. The pressure-sensitive adhesive strip consists of three layers 1, 2, 3, which are disposed congruently one above another, namely the single-layer stretchable carrier 1 and the double-sidedly outer layers 2 and 3 of adhesive employable in accordance with the invention. In order to produce a grip tab for pulling to achieve the extensive stretching (particularly at an angle of more than 45° relative to the bond plane), one end of the pressure-sensitive adhesive strip is made nonadhesive on both sides, by the application of preferably siliconized pieces of film or paper 4.

### EXAMPLES

### Inventive Example 1—Production of an Inventive Pressure-Sensitive Adhesive Strip

The pressure-sensitive adhesive (PSA) containing 62 wt % of the solid acrylonitrile-butadiene rubber Nipol 401, 5 wt % of the liquid acrylonitrile-butadiene rubber Nipol 1312 LV, and 33 wt % of the tackifier resin Dertophene T, based in each case on the dry weight of the PSA, were homogenized as a solvent-based compound in a kneading apparatus with double-sigma kneading hook. The solvent used was methyl ethyl ketone. The kneading apparatus was cooled by means of water cooling. The stated constituents of the adhesive are characterized as follows:

Nipol 401: solid acrylonitrile-butadiene rubber having an acrylonitrile content of 18.5 wt %, a Mooney viscosity (ML 1+4 at 100° C., as per DIN 53523) of 73 to 83, and a T_{g} of −37° C.

Nipol 1312 LV: liquid acrylonitrile-butadiene rubber having an acrylonitrile content of 26.5 wt %, a Brookfield viscosity of 9000 to 16 000 mPa*s, measured with spindel 4, 12 rpm, 50° C., and a T_{g} of −23° C.

Dertophene T: terpene-phenolic resin having a softening point of 95° C.

First of all, in a first step, the solid acrylonitrile-butadiene rubber Nipol 401 was preswollen with the same amount of methyl ethyl ketone for 12 hours at 23° C. This so-called preliminary batch was subsequently kneaded for 2 hours. Thereafter, again, the above-selected amount of methyl ethyl ketone and the liquid acrylonitrile-butadiene rubber Nipol 1312 LV were added in two steps and kneaded in each case for 10 minutes. The Dertophene T tackifier resin was subsequently added as a solution in methyl ethyl ketone with a solids content of 50 wt %, with homogeneous kneading for a further 20 minutes. The final solids content of the PSA was adjusted to 30 wt % by addition of methyl ethyl ketone.

The PSA was subsequently coated onto a liner 23 μm thick, using a coating knife, on a commercial laboratory coating table (for example, from SMO (Sondermaschinen Oschersleben GmbH)). The methyl ethyl ketone was evaporated off at 105° C. in a forced-air drying cabinet for 10 minutes, and hence the PSA was dried. The slot width during coating was set so that the thickness of the PSA layer, achieved after evaporation of the solvent, was 35 μm. A polyurethane carrier having an elongation at break of more than 250%, in both the longitudinal and the transverse directions, and a thickness of 80 μm was subsequently laminated on both sides with a layer of this PSA freed from the solvent. The result was a double-sided adhesive tape having a stretchable polyurethane carrier and two PSA layers based on solid acrylonitrile-butadiene rubber.

### Comparative Example 2—Production of a Noninventive Pressure-Sensitive Adhesive Strip

A 40 wt % strength adhesive solution in benzine/toluene/acetone was prepared from 50.0 wt % of the vinylaromatic block copolymer Kraton D1102AS, 45.0 wt % of the tackifier resin Dercolyte A115, 4.5 wt % of the tackifier resin Wingtack 10, and 0.5 wt % of the aging inhibitor Irganox 1010. The weight fractions of the dissolved constituents are based in each case on the dry weight of the resultant PSA. The stated constituents of the PSA are characterized as follows:

Kraton D1102AS: styrene-butadiene-styrene triblock copolymer from Kraton Polymers with 17 wt % diblock, block polystyrene content: 30 wt %

Dercolyte A 115: solid a-pinene tackifier resin having a ring and ball softening temperature of 115° C. and a DACP of 35° C.

Wingtack 10: liquid hydrocarbon resin from Cray Valley

Irganox 1010: pentaerythritol tetrakis(3-(3,5-di-tert-butyl-4-hydroxyphenyl)-propionate) from BASF SE

The PSA was subsequently coated onto a liner 23 μm thick, using a coating knife, on a commercial laboratory coating table (for example, from SMO (Sondermaschinen Oschersleben GmbH)). The solvent was evaporated off at 105° C. in a forced-air drying cabinet for 10 minutes, and hence the PSA was dried. The slot width during coating was set so that the thickness of the PSA layer, achieved after evaporation of the solvent, was 35 μm. A polyurethane carrier having an elongation at break of more than 250%, in both the longitudinal and the transverse directions, and a thickness of 80 μm was subsequently laminated on both sides with a layer of this PSA freed from the solvent. The result was a double-sided adhesive tape having a stretchable polyurethane carrier and two PSA layers based on vinylaromatic block copolymer.

Results:

The double-sided adhesive tape from example 1, with a stretchable polyurethane carrier and two PSA layers based on solid acrylonitrile-butadiene rubber, relative to the double-sided adhesive tape from example 2, with a stretchable polyurethane carrier and two PSA layers based on vinylaromatic block copolymer, exhibits a significantly reduced susceptibility to tears on extensive stretching at an angle of 90° relative to the bond plane (see table 1). While approximately every third pressure-sensitive adhesive strip tears on stripping of the comparative example, all of the pressure-sensitive adhesive strips from example 1 were strippable without tearing. Surprisingly, therefore, in an adhesive tape having a stretchable carrier, the replacement of PSA layers based on vinylaromatic block copolymer by PSA layers based on solid acrylonitrile-butadiene rubber leads to a significant reduction in the susceptibility to tears, even at a removal angle of 90° relative to the bond plane.

Also surprisingly, in the double-sided adhesive tape, replacing PSA layers based on vinylaromatic block copolymer by PSA layers based on solid acrylonitrile-butadiene rubber leads to an increase in the transverse impact strength, i.e., the shock resistance in the x,y-direction, and also in the penetrative impact strength, i.e., the shock resistance in the z-direction, as demonstrated by the results from the DuPont x,y and DuPont z measurements, respectively.

By means of the stated replacement of the PSA layers in the double-sided adhesive tape, it was also possible to boost the peel adhesion of the pressure-sensitive adhesive strip.

TABLE 1
Characteristics of an inventive and of a noninventive
pressure-sensitive adhesive strip.

| | Trial | | | |
|---|---|---|---|---|
| | Peel adhesion | DuPont x, y | DuPont z | Tears at 90° |
| | [N/cm] | [mJ]¹ | [mJ]² | [%]³ |
| Inventive | 1.1 | 1122 | 633 | 0 |
| example 1 | | | | |
| Comparative | 0.4 | 963 | 584 | 35 |
| example 2 | | | | |

¹Transverse impact strength;
²Penetrative impact strength;
³Susceptibility to tears

### Test Methods

All of the measurements were conducted at 23° C. and 50% relative humidity unless otherwise indicated. The mechanical data and technical adhesive data were ascertained as follows:

### Softening Point Tₛ

The figures for the softening point Tₛ, also called softening temperature, of oligomeric compounds, polymeric compounds, and resins are based on the ring & ball method according to DIN EN 1427:2007 with appropriate application of the provisions (investigation of the oligomer, polymer or resin sample instead of bitumen, with the procedure otherwise retained); the measurements are made in a glycerol bath.

### Elongation at Break, Tensile Strength, 50% Elongation Stress

The elongation at Break, the Tensile Strength, and the stress at 50% elongation of a carrier were measured in a method based on DIN EN ISO 527-3, using a sample strip of the carrier, specimen type 2, having a width of 20 mm, at a separation rate of 100 mm per minute. The initial spacing of the clamping jaws was 100 mm. The test conditions were 23° C. and 50% relative humidity.

### Resilience or Elasticity

The resilience was measured by stretching by 100%, holding in this stretch for 30 seconds, and then releasing. After a waiting time of 1 minute, the length was measured again.

The resilience is then calculated as follows: Rs=((L₁₀₀−L_{end})/L₀)·100

where Rs =resilience in %

L₁₀₀: length after stretching by 100%

L₀: length before stretching

L_{end}: length after the relaxation of 1 min.

The resilience here corresponds to the elasticity.

### Susceptibility to Tears

20 strips 10 mm wide and 40 mm long are punched from the adhesive tape under investigation. These strips are bonded over a length of 30 mm to a PC plate conditioned with ethanol, thus leaving a grip tab 10 mm long. A second PC plate is adhered to the second side of the bonded strips, in such a way that the two PC plates lie flush over one another. The assembly is rolled down 10 times using a 4 kg roller (five times backward and forward). After a peel increase time of 48 hours, the 20 strips are stripped manually from the bonded joint, using the grip tab,

a) at a 90° angle relative to the bond plane, or alternatively

b) at a 0° angle (i.e., in the bond plane).

An evaluation is made of how many of the 20 specimens tear on stripping at the selected angle, the result being reported in %.

### Transverse Impact Strength (DuPont Test in the x-y Plane)

A sample of the pressure-sensitive adhesive strip under investigation was cut out in the form of a square frame (outer dimensions 33 mm×33 mm; frame width 2.0 mm; inner dimensions (window cutout) 29 mm×29 mm). This sample was adhered onto a PC frame (outer dimensions 45 mm×45 mm; frame width 10 mm; inner dimensions (window cutout) 25 mm×25 mm; thickness 3 mm). Adhered on the other side of the pressure-sensitive adhesive strip was a PC window of 35 mm×35 mm. PC frame, adhesive tape frame, and PC window were bonded in such a way that the geometric centers and the diagonals lay over one another in each case (corner to corner). The bond area was 248 mm². The bond was pressed at 248° N for 5° s and stored for 48 hours with conditioning at 23° C./50% relative humidity.

Immediately after storage, the adhesive assembly of PC frame, pressure-sensitive adhesive strip, and PC window was clamped by the protruding edges of the PC frame into a sample mount in such a way that the assembly was aligned vertically. The sample mount was then inserted centrally into the holder provided on the DuPont Impact Tester. The impact head, weighing 300° g, was inserted such that the rectangular striking geometry with the dimensions of 20 mm×3 mm lay centrally and flushly on the upwardly directed end-face side of the PC window.

A weight having a mass of 150° g was dropped from a height of 3° cm (measurement conditions 23° C., 50% relative humidity) vertically onto the corresponding arrangement of the assembly formed of sample mount, sample, and impact head, the weight being guided on two guide rods. The height of the drop weight was increased in steps of 3° cm until the impact energy introduced destroys the sample as a result of the transverse impact load, and the PC window parted from the PC frame.

In order to be able to compare trials with different samples, the energy was calculated as follows:

E[j]=height [m]*mass of weight [kg]*9.81 kg/m*s²

Five samples per product were tested, and the mean energy value was reported as the characteristic number for the transverse impact strength.

### Penetrative Impact Strength (DuPont Test in the z Plane)

A sample of the pressure-sensitive adhesive strip under investigation was cut out in the form of a square frame (outer dimensions 33 mm×33 mm; frame width 2.0 mm; inner dimensions (window cutout) 29 mm×29 mm). This sample was adhered onto a PC frame (outer dimensions 45 mm×45 mm; frame width 10 mm; inner dimensions (window cutout) 25° mm×25 mm; thickness 3 mm). Adhered on the other side of the pressure-sensitive adhesive strip was a PC window of 35 mm×35 mm. PC frame, adhesive tape frame, and PC window were bonded in such a way that the geometric centers and the diagonals lay over one another in each case (corner to corner). The bond area was 248 mm². The bond was pressed at 248 N for 5 s and stored for 48 hours with conditioning at 23° C./50% relative humidity.

Immediately after storage, the adhesive assembly of PC frame, pressure-sensitive adhesive strip, and PC window was clamped by the protruding edges of the PC frame into a sample mount in such a way that the assembly was aligned horizontally. In this case, the PC frame lies flat on the protruding edges on the sample mount, so that the PC window was in free suspension (held by the adhesive tape specimen) beneath the PC frame. The sample mount was then inserted centrally into the holder provided on the DuPont Impact Tester. The impact head, weighing 150 g, was inserted in such a way that the circular striking geometry with a diameter of 24 mm lay centrally and flushly on the surface of the PC window, which was freely accessible from above.

A weight having a mass of 150 g was dropped from a height of 5 cm (measurement conditions 23° C., 50% relative humidity) vertically onto the corresponding arrangement of the assembly formed of sample mount, sample, and impact head, the weight being guided on two guide rods. The height of the drop weight was increased in steps of 5 cm until the impact energy introduced destroys the sample as a result of the penetrative impact load, and the PC window parted from the PC frame.

In order to be able to compare trials with different samples, the energy was calculated as follows:

E=height [m]*mass of weight [kg]*9.81 kg/m*s²

Five samples per product were tested, and the mean energy value was reported as the characteristic number for the penetrative impact strength.

### Diameter

The average diameter of the cavities formed by the microballoons in a PSA layer is determined on the basis of cryofracture edges of the pressure-sensitive adhesive strip under a scanning electron microscope (SEM) at 500-times magnification. The diameter of each of the microballoons in the PSA layer under investigation that are visible on SEM micrographs of 5 different cryofracture edges of the pressure-sensitive adhesive strip is ascertained graphically, with the arithmetic mean of all diameters ascertained in the 5 SEM micrographs representing the average diameter of the cavities of the PSA layer that are formed by the microballoons, in the sense of the present patent application. Ascertaining the diameters of the microballoons visible on the micrographs graphically is done by taking the maximum enlargement in any (two-dimensional) direction for each individual microballoon in the PSA layer under investigation, from the SEM micrographs, and regarding that maximum enlargement as the diameter of said microballoon.

### Glass Transition Temperature (T_{g})

Glass transition points—referred to synonymously as glass transition temperatures—are reported as the result of measurements by dynamic scanning calorimetry (DSC) in accordance with DIN 53 765, particularly sections 7.1 and 8.1, but with uniform heating and cooling rates of 10 K/min in all heating and cooling steps (compare DIN 53 765; section 7.1; note 1). The initial sample mass is 20 mg.

### DACP

5.0 g of test substance (the tackifier resin specimen under investigation) are weighed out in a dry test tube, and 5.0 g of xylene (isomer mixture, CAS [1330-20-7],≥98.5%, Sigma-Aldrich #320579 or comparable) are added. The test substance is dissolved at 130° C. and then cooled down to 80° C. Any xylene that escapes is made up with further xylene, to restore 5.0 g of xylene. Then 5.0 g of diacetone alcohol (4-hydroxy-4-methyl-2-pentanone, CAS [123-42-2], 99%, Aldrich #H41544 or comparable) are added. The test tube is shaken until the test substance has dissolved completely. For this purpose the solution is heated to 100° C. The test tube with the resin solution is subsequently inserted into a Novomatics Chemotronic Cool cloud point measuring instrument and heated therein to 110° C. It is cooled down with a cooling rate of 1.0 K/min. The cloud point is detected optically. For this purpose, the temperature at which the turbidity of the solution is 70% is recorded. The result is reported in ° C. The lower the DACP, the higher the polarity of the test substance.

### Density

The density of unfoamed and foamed layers of adhesive is ascertained by forming the ratio of coatweight to thickness of the layer of adhesive applied to a carrier.

The coatweight can be determined by determining the mass of a section of a layer of adhesive of this kind applied to a carrier, the section being defined in terms of its length and its width, and subtracting the (known or separately ascertainable) mass of a section of the carrier used that has the same dimensions.

The thickness of a layer of adhesive can be determined by determining the thickness of a section of such a layer of adhesive, applied to a carrier, that section being defined in terms of its length and its width, and subtracting the (known or separately ascertainable) thickness of a section of the carrier used that has the same dimensions. The thickness of the layer of adhesive can be determined using commercial thickness gauges (sensor instruments) with accuracies of less than 1 μm deviation. Where fluctuations in thickness are found, the mean value of measurements at not less than three representative sites is reported, hence in particular not including measurement at wrinkles, creases, nibs, and the like.

### Coatweight

The coatweight of a PSA layer in g/m² can be determined by determining the mass of a section of a layer of adhesive of this kind applied to a carrier, the section being defined in terms of its length and its width, and subtracting the (known or separately ascertainable) mass of a section of the carrier used that has the same dimensions.

### Thickness

Like the thickness of the layer of adhesive already, the thickness of a pressure-sensitive adhesive strip or of a carrier may also be ascertained using commercial thickness gauges (sensor instruments) with accuracies of less than 1 μm deviation. Where fluctuations in thickness are found, the mean value of measurements at not less than three representative sites is reported, hence in particular not including measurement at wrinkles, creases, nibs, and the like.

### 180° Peel Adhesion Test

The peel strength (peel adhesion) is tested in a method based on PSTC-1.

An adhesive tape in the form of a strip 0.5 cm wide, consisting of (i) a PET film 23 μm thick and etched with trichloroacetic acid, and (ii) a pressure-sensitive adhesive strip applied to said film, in the form of a double-sided adhesive tape as described in the present patent application, is bonded to the test substrate in the form of an ASTM steel plate, the surface of which has been cleaned with acetone beforehand, by rolling down the tape back and forth five times using a 4 kg roller. The plate is clamped in and the adhesive tape is removed via its free end on a tensile testing machine with a velocity of 300 mm/min and at a peel angle of 180° from the plate, and the force required to achieve this is determined. The results of measurement are reported in N/cm (i.e. normalized to the width of the adhesive tape) and are averaged from three measurements.

### Solids Content

The solids content is a measure of the fraction of unevaporable constituents in a PSA. It is determined gravimetrically, by weighing the PSA, then evaporating off the evaporable fractions in a drying cabinet at 120° C. for 2 hours, and weighing the residue.

1. A pressure-sensitive adhesive strip comprising a carrier and a layer HS1 of pressure-sensitive adhesive that is disposed on one of the surfaces of the carrier, where:
(i) the carrier in the longitudinal direction and/or the transverse direction has an elongation at break of at least 250% and
(ii) the layer HS1 of pressure-sensitive adhesive consists of a pressure-sensitive adhesive which comprises as base polymer at least one solid acrylonitrile-butadiene rubber and further comprises at least one tackifier resin, with the fraction of tackifier resin totaling 30 to 130 phr.

2. The pressure-sensitive adhesive strip as claimed in claim 1, wherein disposed on the surface of the carrier opposite the layer HS1 of pressure-sensitive adhesive is a layer HS2 of pressure-sensitive adhesive.

3. The pressure-sensitive adhesive strip as claimed in claim 2, wherein the layer HS2 of pressure-sensitive adhesive likewise consists of a pressure-sensitive adhesive which comprises as base polymer at least one solid acrylonitrile-butadiene rubber and further comprises at least one tackifier resin, with the fraction of tackifier resin totaling 30 to 130 phr.

4. The pressure-sensitive adhesive strip as claimed in claim 1, wherein the acrylonitrile content in the solid acrylonitrile-butadiene rubber of the layer HS1 pressure-sensitive adhesive is between 10 and 45 wt %.

5. The pressure-sensitive adhesive strip as claimed in claim 1, wherein the pressure-sensitive adhesive based on solid acrylonitrile-butadiene rubber of the layer HS1 pressure-sensitive adhesive comprises as further base polymer at least one liquid acrylonitrile-butadiene rubber, with the acrylonitrile content in the at least one liquid acrylonitrile-butadiene rubber between 10 and 45 wt %.

6. The pressure-sensitive adhesive strip as claimed in claim 1, wherein in the pressure-sensitive adhesive based on solid acrylonitrile-butadiene rubber of the layer HS1 pressure-sensitive adhesive, the base polymer consists exclusively of acrylonitrile-butadiene rubber, with no polymer other than the acrylonitrile-butadiene rubber being present in the pressure-sensitive adhesive.

7. The pressure-sensitive adhesive strip as claimed in claim 1, wherein in the pressure-sensitive adhesive based on solid acrylonitrile-butadiene rubber of the layer HS1 pressure-sensitive adhesive, there is a blend of at least three synthetic nitrile rubbers S1, S2, and S3, where:
(a) the blend is microphase-separated, characterized by at least three different glass transition temperatures in the DSC,
(b) at least one glass transition temperature is greater than 10° C. and one glass transition temperature is less than −20° C.,
(c) the nitrile rubber or rubbers S1 has/have an acrylonitrile fraction of greater than or equal to 35 wt %,
(d) the nitrile rubber or rubbers S2 has/have an acrylonitrile fraction of greater than 25 wt % and less than 35 wt %, and
(e) the nitrile rubber or rubbers S3 has/have an acrylonitrile fraction of less than or equal to 25 wt %.

8. The pressure-sensitive adhesive strip as claimed in claim 1, wherein in the pressure-sensitive adhesive based on solid acrylonitrile-butadiene rubber of the layer HS1 pressure-sensitive adhesive, the fraction of tackifier resin totals 40 to 120 phr.

9. The pressure-sensitive adhesive strip as claimed in claim 1, wherein in the pressure-sensitive adhesive based on solid acrylonitrile-butadiene rubber of the layer HS1 of pressure-sensitive adhesive, the tackifier resin used comprises terpene-phenolic resin and/or polyterpene.

10. The pressure-sensitive adhesive strip as claimed in claim 2, wherein the layers HS1 and HS2 of pressure-sensitive adhesive have an identical composition.

11. The pressure-sensitive adhesive strip as claimed in claim 1, wherein disposed on the surface of the carrier opposite the layer HS1 of pressure-sensitive adhesive is a layer HS2 of pressure-sensitive adhesive which consists of a pressure-sensitive adhesive whose base polymer consists exclusively of polymer which is different from acrylonitrile-butadiene rubber, with the pressure-sensitive adhesive comprising as base polymer at least one vinylaromatic block copolymer.

12. The pressure-sensitive adhesive strip as claimed in claim 11, wherein in the pressure-sensitive adhesive of the layer HS2 of pressure-sensitive adhesive, the base polymer consists exclusively of vinylaromatic block copolymer, with no polymer other than the vinylaromatic block copolymer being present in the pressure-sensitive adhesive.

13. The pressure-sensitive adhesive strip as claimed in claim 11, wherein the pressure-sensitive adhesive of the layer HS2 of pressure-sensitive adhesive further comprises at least one tackifier resin.

14. The pressure-sensitive adhesive strip as claimed in claim 1, wherein the layer HS1 of pressure-sensitive adhesive are outer layers of pressure-sensitive adhesive.

15. The pressure-sensitive adhesive strip as claimed in claim 1, wherein the layer HS1 of pressure-sensitive adhesive has a thickness of 10 to 200 μm.

16. The pressure-sensitive adhesive strip as claimed in claim 1, wherein the carrier in the longitudinal direction and/or the transverse direction has an elongation at break of at least 300%.

17. The pressure-sensitive adhesive strip as claimed in claim 1, wherein the carrier in the longitudinal direction and/or the transverse direction, has a resilience of above 50%.

18. The pressure-sensitive adhesive strip as claimed in claim 1, wherein the carrier in the longitudinal direction and/or the transverse direction has a 50% elongation stress of less than 20 N/mm2.

19. The pressure-sensitive adhesive strip as claimed in claim 1, wherein the carrier has at least one layer which consists of polyurethane.

20. The pressure-sensitive adhesive strip as claimed in claim 1, wherein the carrier consists only of a single layer. pg,46

21. The pressure-sensitive adhesive strip as claimed in claim 1, wherein the carrier is 10 to 200 μm.
